(19) United States
(12) Patent Application Publication
(10) Pub. No.: US 2007/0230720 A1
(43) Pub. Date: Oct. 4, 2007

(54) Acoustic Element

(76) Inventor: Lars Stromback, Linkoping (SE)

Correspondence Address: HAYES SOLOWAY P.C., 3450 E. SUNRISE DRIVE, SUITE 140, TUCSON, AZ, 85718, US

(21) Appl. No.: 11/568,179

(22) PCT Filed: Apr. 22, 2005
(86) PCT No.: PCT/SE05/00579

§ 371 Date: Oct. 20, 2006

(30) Foreign Application Priority Data
Apr. 23, 2004 (SE) 0401040-1

(51) Int. Cl. H04R 23/00

(52) U.S. Cl. 381/165

(57) ABSTRACT

Loudspeaker ROTOSUB including a motor driven rotor provided with wings or blades that are adjustable to their pitch and where the pitch is modulated by a signal, in particular electric, corresponding to a desired sound. In particular at very low frequencies the loud speaker rotor that during each sound wave length has time to rotate many revolutions can move large amounts of air that in turn can provide a large air and sound pressure. The technic is based on the generation of sound waves by modulating the angles of the wings. At low frequencies the rotor has time to rotate several revolutions per signal cycle which provides increased pressure. Since the wings can be pivoted in arbitrary angles the pressure can be controlled in the desired way.

### CROSS REFERENCE TO RELATED APPLICATIONS

This application is a continuation-in-part of PCT International Patent Application Serial No. PCT/SE2005/000579 filed Apr. 22, 2005, designating the United States. Priority is also claimed from Swedish Application Serial No. 0401040-1, filed Apr. 23, 2004.

### BACKGROUND OF THE INVENTION

This invention concerns acoustic elements, as loudspeakers or microphones in particular for lower frequencies. Bass loudspeakers must today in order to achieve a good sound reproduction and strength of sound be large and also frequently become expensive. When the available space is insufficient, as in cars, one simply have to accept that the sound reproduction is afflicted. In view of the above problem there is a great need for improved loudspeakers for lower frequencies. In particular there is a great need for small loudspeaker elements for lower frequencies since in many cases large loudspeakers can not be installed. The object of the invention is therefor to achieve a compact and efficient loudspeaker and microphone respectively that can cope with low frequencies and that can be made small.

### SUMMARY OF THE INVENTION

In accordance with the invention the above object is solved by the loudspeaker including a wing provided rotor (loudspeaker rotor) that at use is rotated and where the pitch of the wings is modulated in unison with the tone or sound or sound pressure that is to be achieved. By alternatingly adjust the wings for pushing the air (positive compression) towards the listener and in the opposite direction respectively (negative compression) from the listener the same compression conditions are achieved as at the vibration of a traditional loudspeaker membrane. With an appropriate control of the pitch of the wings desired air transport and sound pressure respectively can be achieved in every instant. By altering the pitch very slowly extremely low frequency sounds can be generated, even below the audible range. The momentary sound pressure of the sound is thus controlled by means of an electric signal to the loudspeaker rotor for control of the pitch of its wings positive signal-positive pressure and flow and negative signal-negative pressure and flow. The sound level of the generated sound can either be controlled by differently great wing angles or by the speed, this since both measures can influence the sound pressure and the transported amount of air respectively in each sound wave.

One can also conceive that the sound level is controlled as a combination of the inclination of the wings of the loudspeaker rotor and the speed respectively. As is realized the reproduced sound must not necessarily be sine shaped but also sound waves compounded of several tones can be generated with the device in accordance with the invention by controlling the wing angles corresponding to the compound desired shape of the sound pressure curve shape.

If more power is desired several loudspeaker rotors according to the invention can be used in parallel alternatively larger loudspeaker rotors may be used. One can also consider to use rotors mounted after each other in order to increase the driving ability, that is the maximally achievable sound pressure. Advantageously one may give the rotors alternating rotation direction and opposed pitch angles in order to decrease turbulence, optimize the airflow and increase efficiency.

By using a rotor with pivotable wings one may instead make a microphone that also may be used for very low tones. By allowing the wings to be freely moveable these may at rotation of the rotor be controlled by the sound inducing airflow back and forth that in a suitable way, for instance optical or electrical way can be detected by a detecting of the angle displacement of the wings.

One can also consider to use the invention in other media than air, for instance water, to generate or detect sound waves or acoustic phenomena.

### BRIEF DESCRIPTION OF THE DRAWINGS

Further advantages and characteristics of the invention as well as further developments of the invented concept are apparent from the patent claims and the following described embodiment with reference to the enclosed drawings.

FIG. 1 shows schematically the relation between wing angle and sound pressure graph.

FIG. 2 shows how the wing position is varied with a varying sound pressure as a result.

FIG. 3 shows the relation between sound pressure and r.p.m.

FIG. 4 shows the relation between sound pressure and frequency at different r.p.m:s

FIG. 5 shows schematically a loudspeaker rotor in accordance with the invention that is driven by a motor.

FIG. 6 shows wings and compensation weights at force balancing via centrifugal force.

FIG. 6.1 shows schematically the compensation weights in the rotor.

FIG. 6.2 shows schematically a wing in the rotor.

FIG. 6.3 shows schematically a wing pivot axle in the rotor.

FIG. 6.4 shows schematically a wing holder in the rotor.

FIG. 7 shows the wing forces and the pivoting force that is generated by the centrifugal force.

FIG. 8 shows the compensation forces and the pivoting force that is generated by the centrifugal force.

FIG. 9 shows schematically the wing design at force balancing via asymmetric wing design.

FIG. 9.1 shows schematically the smaller part of the wing.

FIG. 9.2 shows schematically the larger part of the wing.

FIG. 9.3 shows schematically a wing holder in the rotor.

FIG. 10 shows the wing forces and the pivoting force generated by the centrifugal force.

FIG. 11 shows the compensation forces from wind and the pivot force that is generated by the asymmetric wing design.

FIG. 12 shows blade for force linearizing.

FIG. 12.5 shows blade with extra wing area for force linearizing.

FIG. 13 shows the modulation forces at angled and non angled state for force linearizing.

FIG. 14 shows a rotor with blades larger than 80%, area subjected to pressure loss is marked.

FIG. 15 shows a rotor with blades smaller than 80%.

FIG. 16 shows schematically the components modulation rotor, flow brake, cavity and outlet.

FIG. 16.1 shows modulation rotor component seen from above.

FIG. 16.2 shows wings of modulation rotor seen from above.

FIG. 16.3 shows modulation rotor component and flow brake seen from the side.

FIG. 16.3 shows the outlet to the flow brake seen from below.

FIG. 17 shows schematically the modulation rotor applied to a flow brake with braking material in the cavity and flow brake in the outlet.

FIG. 17.1 shows schematically component modulation rotor.

FIG. 17.2 shows schematically the air brake with brake material in the cavity.

FIG. 17.3 shows schematically the outlet grid with acoustic brake.

FIG. 18 shows schematically the modulation rotor applied to a flow brake without braking material in the cavity with flow brake in the outlet.

FIG. 18.1 shows schematically the component modulation rotor.

FIG. 18.2 shows schematically the air brake without brake material in the cavity.

FIG. 18.3 shows schematically the outlet grid with acoustic brake.

FIG. 19 shows the rotor component from different angles.

FIG. 20 shows the outer wall (tube) form different angles.

FIG. 21 shows the rotor mounted in the tube without seals with angled and non angled wings.

FIG. 22 shows the rotor mounted in the tube with spherically cut seals with angled and non angled wings.

FIG. 23 shows a close up of the rotor mounted in the tube with spherically cut seals.

FIG. 24 shows a close up of the rotor mounted in the tube with spherically cut seals and bellow seal.

### DETAILED DESCRIPTION OF PREFERRED EMBODIMENTS

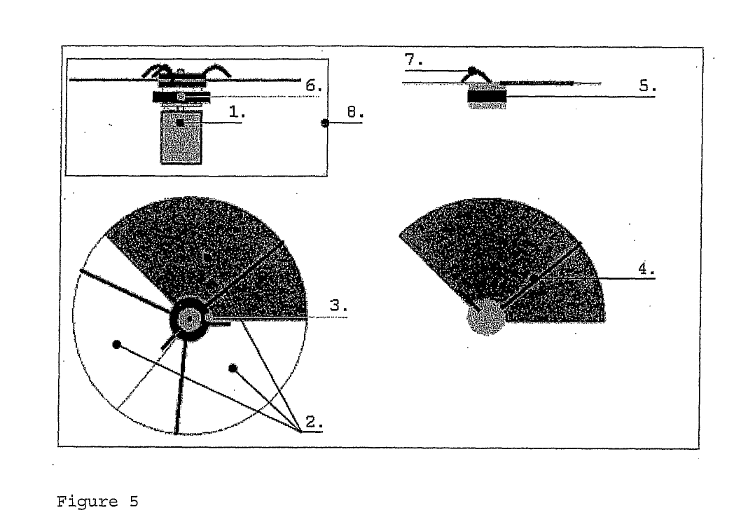

The loudspeaker shown in FIG. 5 in accordance with the invention includes a direct driven rotor, that is the rotor is arranged directly on the motor axle of a motor. The loudspeaker rotor has in this example three wings 2, which in their inner ends are pivotable arranged in a hub 3. The wings are pivotable around essentially radial pivot axles 4. The hub 3 is rotated by the motor 1. Each wing in this example has an area corresponding to approximately one third of a circle ring and is in the inner end at a distance from the pivot bering via an arm 7 connected to a coil axially moveable relative the rotor so that a an axial movement of the coil 5 pivots the wings. The coil 5 is surrounded by a fixed permanent magnet 6 and is fed with electricity against the influence of restraining springs so that it is moved forwards or backwards depending on the direction of electrical current. Advantageously the pivot axles of the wings are situated slightly in front of the pressure center (approximately the center of gravity of the wing area) so that the wings moves towards a center position without driving of the air when the coil is not fed with electric current. At the same time the required forces for the pivoting of the wings around the pivot axles of these become very small. This condition can either be used for sound amplifying alternatively to compensate a possible week coupling, caused by the construction, between magnets and coil in the wing manoeuvering.

For the generation of sound an electrical signal is applied to the coil that owing to this swing back and forth. The movement is via the arms linked to the wings at which the wing angle is altered in a corresponding way. Energy for the moving of air forth and back, that is the sound generation is supplied by the motor driving the loudspeaker rotor. As a consequence of this the loudspeaker element according to the invention will function as a power amplifier.

With decreasing sound frequency the number of revolutions that the loud speaker rotor rotates during a sound wave length will increase which increases the transported amount of air and thus the sound pressure can be retained at low frequencies differing from the case at ordinary loudspeakers. The device according to the invention can principally generate sounds of arbitrary low frequency. For sound waves with higher frequency the wings of the loudspeaker rotor should not be to heavy. One can therefor consider to use many smaller wings as in a turbine or to fabricate comparatively small loudspeakers that when more power is needed can be put together in panels. Furthermore the loudspeaker element in accordance with the invention can be arranged together with loudspeaker elements of conventional type in order to achieve a sufficient frequency range. Within the frame of the inventive thought the manoeuvering of the loudspeaker rotor can be designed in different ways as to the journaling of the wings.

The manoeuvering can be electromagnetic with one or several magnets fixed to the wings or these may be magnetic in themselves in order to be influenced by a fixed coil. Alternatively a coil arranged in the rotor may mechanically influence the wings when the current through the coil is altered and this is located in a fixed magnetic field generated by a fixed permanent magnet. Each wing may be provided with one or several coils as alternative. One may also consider to control the wings via a piston or coil placed in the center of the rotor where the inner part of the wing has a mechanical coupling to the piston or coil. Also the fastening of the wings and journaling thereof can be achieved in different ways and one can for instance consider the loudspeaker rotor being made of thin iron panel that has been punched, embossed and magnetized, and surrounded by one or several fixed coils. Within the concept of the invention one can also consider to use other physical phenomena to achieve the required pivoting/bending of the wings of the rotor, as for instance piezoelectric elements.

The loudspeaker rotor need not necessarily be flat or propeller like as above but one can also consider to use a drumlike device with blades adjustable to their angles.

The loudspeaker rotor in accordance with the invention is in much similar to a fan why one can further consider using it for the transportation of air for ventilation purposes. This can be done by instead of varying the pitch of the wings giving these a constant pitch (for the time that ventilation is desired). The loudspeaker rotor then only serves as a fan. If one instead choose to allow the pitch to vary with intended sound signals, but not around the center position where the rotor does not transport any air but around a position with a certain pitch fan and loudspeaker function is obtained at the same time.

The loud speaker element in accordance with the invention can also be arranged in a ventilation outlet by journaling the wings freely moveable with the journaling axle somewhat in front of the pressure center, and with electromagnetic pitch control. This can for instance be done by providing the wings at their outer edges with magnets with circumferential extension. Outside a coil is placed around loud speaker rotor. With an increasing amount of air that is pushed through the loudspeaker rotor by the ventilation system the wings of the rotor will deflect from their middle position, the electromechanically enforced additional angling of the wings will oscillate around the ventilation angling so that the sound is generated independent of the ventilation. By the integration with the ventilation system automatically a discrete mounting is obtained and large parts corresponding to loudspeaker boxes (in the shape of the air conduits) which reduces the distortion of the sound. In particular in cars this may mean a considerable improvement of the sound quality.

In the above described embodiment the motor is coupled directly to the loud speaker rotor, but if so desired one can also consider belt drive. Either with one rotor per motor or several rotors that are in common driven bye one motor. Also several loudspeakers rotors may be arranged on one and the same axle to increase the acoustic driveability. The wing pitch may in a corresponding way be controlled in common or individually for several rotors. The loud speaker rotors may further be driven by power net connected motors while the wing angle is controlled by signals from sound amplifiers. At this the need for powerful amplifiers as well as thick and low-ohmic connections between amplifier and bass loudspeakers is reduced.

Since loudspeakers in accordance with the invention can let through an air flow the wind resistance at outdoor locations is reduced, this counter acts the pressure variations that otherwise arise. A more natural sound with better sound quality can therefor be achieved outdoors.

In addition to generate audible sound loudspeakers in accordance with the invention be used to generate infrasounds. In this way it becomes possible to anhilate existing infrasounds which has previously been a problem especially in view of infrasound being able to result in nausea, headache and cause drivers to fall a sleep.

If no force is fed to the wings for the pivoting of these when the rotor is rotated the wings alter their inclination according to the flow so that the resistance become as small as possible and one can by recording the varying pitch of the wings for instance by connecting the coil to a measuring instrument alternatively optically register the wing pitch so that a “loudspeaker rotor” instead may function as a microphone in particular for low frequencies even if a superimposed constant air flow is present. If sound is to be detected in a constant flow the wings work with a constant pitch corresponding to the constant flow. Around this zero position the wings pivot at the detection of sound or flow variations. The microphone in accordance with invention has the advantage that it already before the detection separates the constant flow component from the varying one which reduces the noise in the measured sound. If so is desired the average flow may be detected by noting the mean pivoting of the wing pitch.

Advantageously the rotor is driven at a constant speed or at least with monitored or controlled rpm since the rotor speed has a large influence on the generated sound amplitude and the instant sound power. One can also consider providing the rotor with a flywheel or a large rotating mass in order to provide a steady constant rotation even if the wing pitch and thereby the braking is changed due to the delivered sound volume. The motor can also be provided with active control where a speed control compensate the speed variations that load variations may generate.

One can also use motors with constant speed or drive the motor with a power addition corresponding to the delivered sound. One can also consider instead to monitor the speed so that the reduction in speed can be compensated with increased wing deflection so that intended sound pressure can be generated.

Since the angle of the wings directly modulate the sound pressure one may advantageously use active feedback to ascertain blade angle. The angle detection can then be implemented with optical/piezoelectrical or electromechanical sensors.

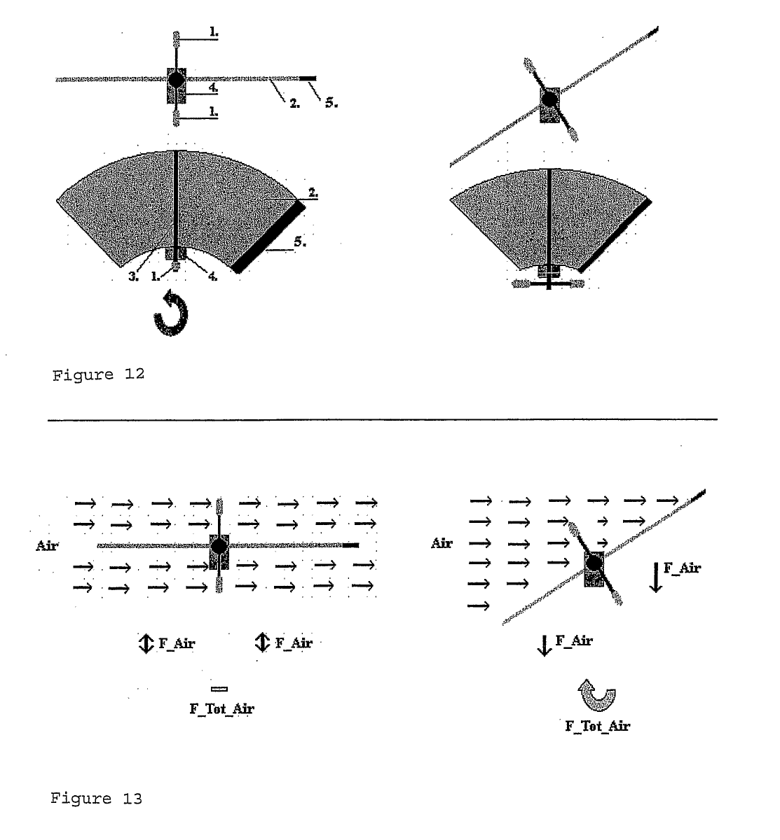

In FIG. 5 the pivot axles of the wings are arranged unsymmetrically on the wings of the rotor. The rotor rotates clockwise. This result in the pushing force on that half of the wing that is behind the pivoting center is slightly larger than the pressure on the wing part that is in front of the pivot axle half and the wing will thus always generate a counter force against an increased pivoting. This in turn means that the larger pivoting or pitch for the wing that is to be desired the more power must be applied and in this way a linear acoustic response is obtained from the rotor and the wing pitch can be controlled through force influence (FIGS. 15, 12, 13).

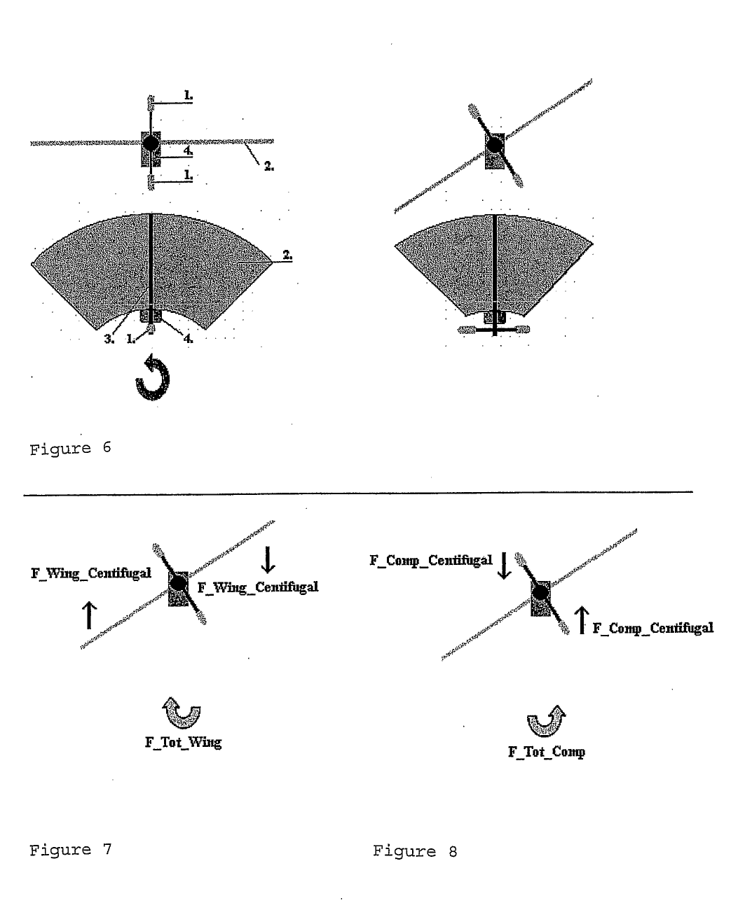

When the wings of the rotor from an entirely flat position is given an increased angle the pivoting of each wing takes place around its own axle. At a rotor with wider wings as for instance the one shown in FIG. 5 the wing tips will move perpendicularly inward towards the pivot axles of the wings, that is also inward towards the rotational center of the rotor. The wings must thus move against the influence of the centrifugal force that acts on the wings. At high rotor speeds these centrifugal forces may be become most considerable and they brake the electrical deflection of the motor wings. This increase the power consumption in an undesired way. In order to remedy this as is shown i FIG. 6 balance element 6.1 are arranged perpendicularly relative the area 6.2 of the wings. The balance elements have the shape of arms perpendicular to the surface of the blade fastened for instance in the inner ends of the wing axles provided with weights in their outer ends. These weights will as the wing tips move perpendicularly in relation to the pivot axles of the wings. Through the perpendicular arrangement these weights will at a pivoting of the wing move radially outward in relation to the rotor axle. By appropriate dimensioning of the weights it is possible to achieve centrifugal forces (FIG. 8) that balance the centrifugal forces from the wings (FIG. 7) efficiently reducing the control forces that otherwise must be delivered to the wings (FIGS. 6, 7, 8).

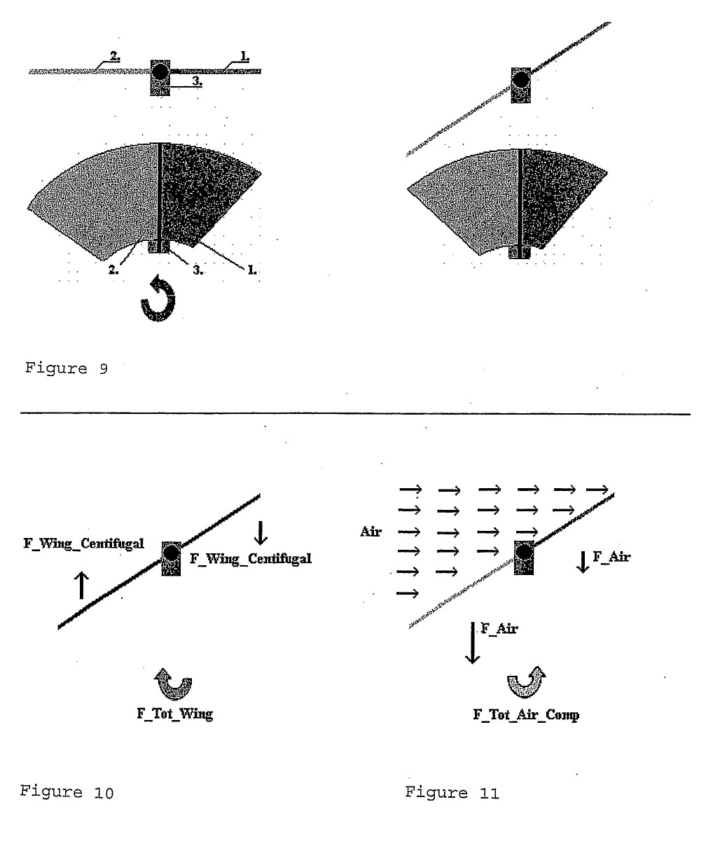

By designing the wing unsymmetrically (FIG. 9) and placing the pivot axle of each wing behind the center of pressure seen in the rotational direction also force generated by the unsymmetry (FIG. 11) may be used to compensate the pivoting generated by the centrifugal force (FIG. 10). (FIGS. 9, 10, 11)

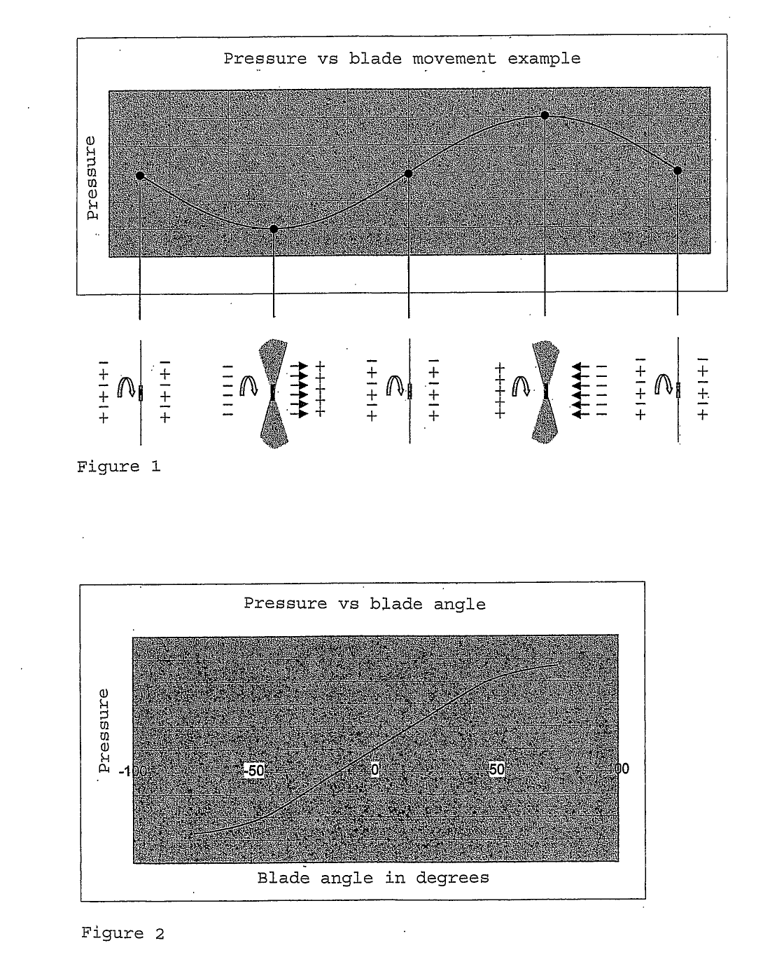

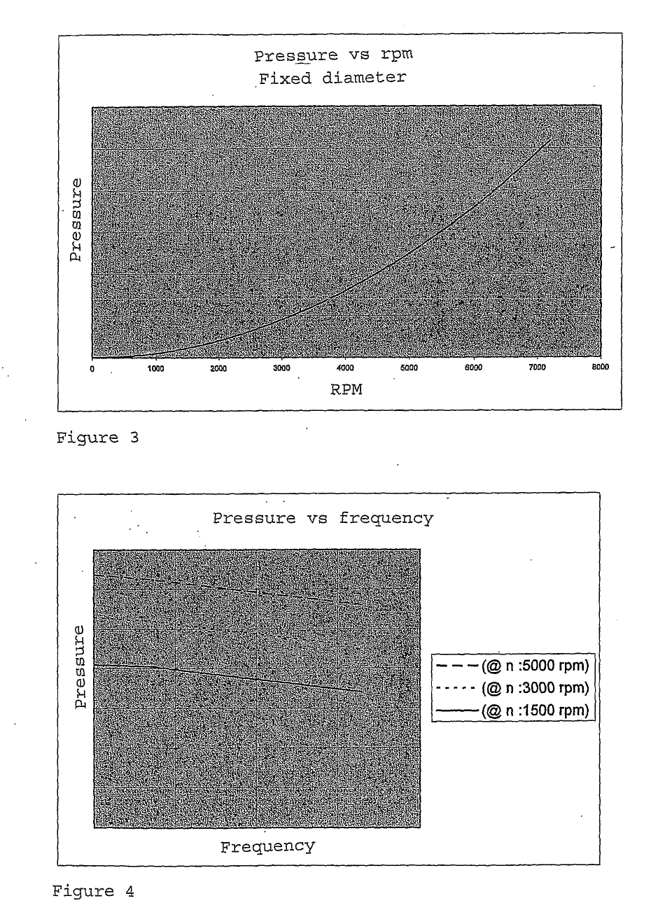

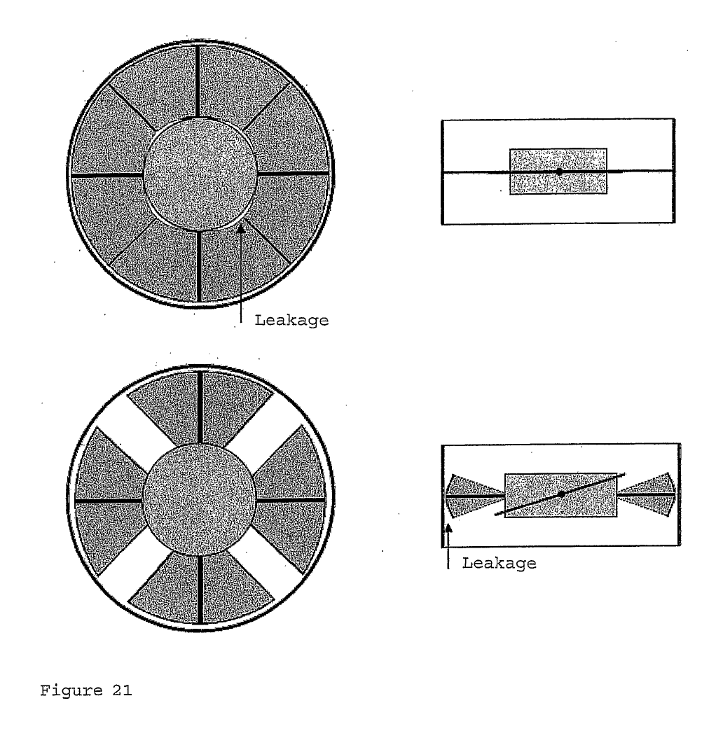

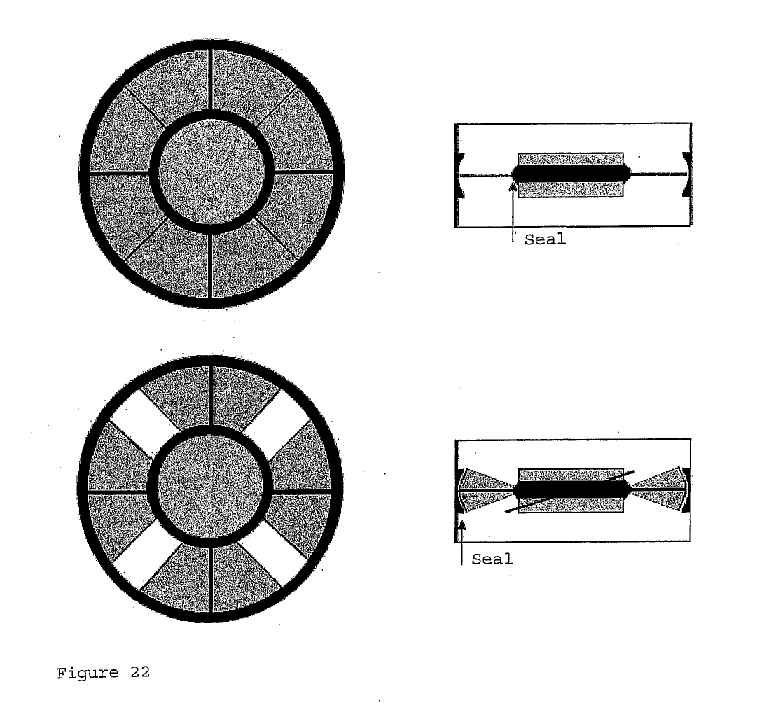

In order to prevent air transport between the sides of the rotor at its outer end this is advantageously arranged in a tube or corresponding housing (FIG. 2). As described above with reference to FIG. 21 however the outer corners of the wings move inward as the pitch is increased. At the same time the inner corners move outward. This cause leakage between the front and back side of the rotor, which impairs the efficiency of the device. Therefor the rotor blades and the surrounding housing and the rotor hub respectively are designed in the way shown in FIG. 22. The sealing surface in the house surrounding the rotor is shaped spherical with the center of the spherical surface in the center of the rotor where the pivot axles of the wings intersect the rotor axle. At a pivoting of the wings the circular outer edges of the wings will then all the time lie close to the inner surface of the housing.

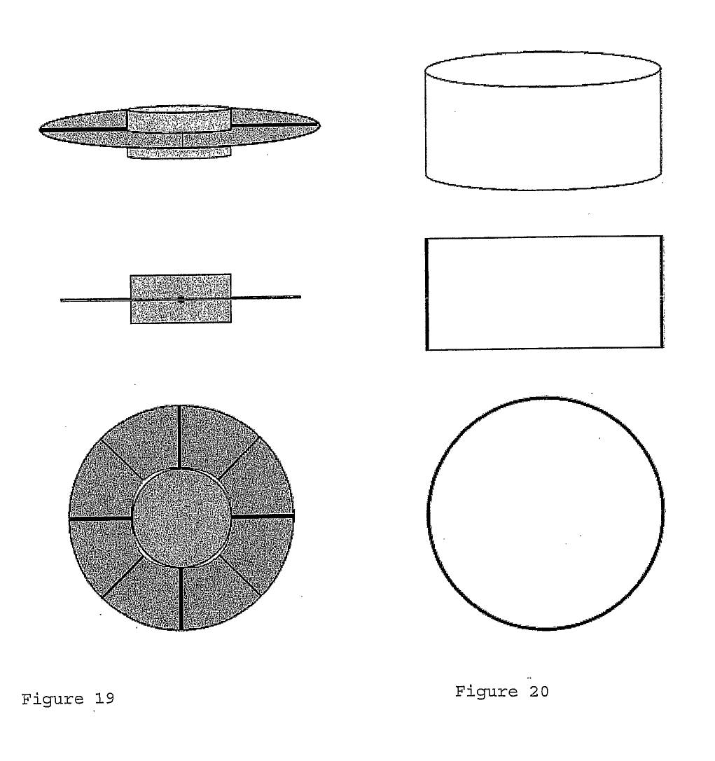

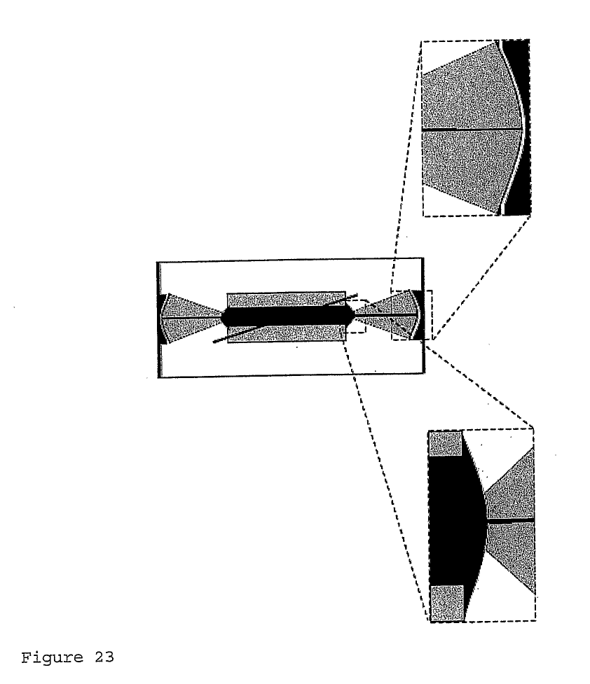

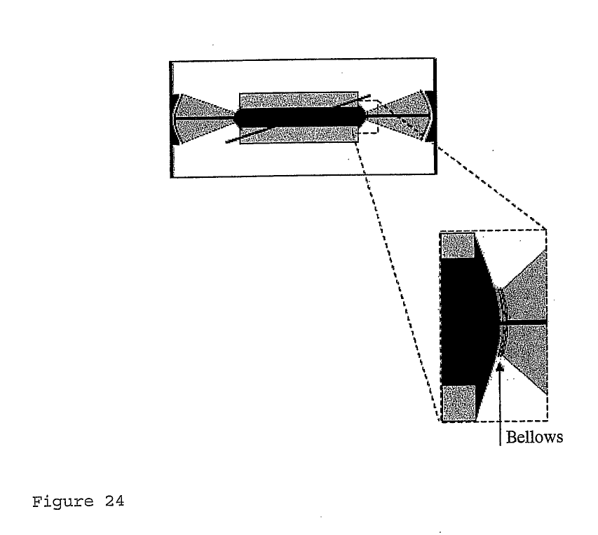

At the inner edges of the wings also the hub of the rotor is made with a rotational symmetric sealing surface and a corresponding shaping of the inner edges of the wings to achieve a sealed condition (FIG. 23). By also here using a spherical sealing surface on the hub with the center on the rotation axle of the rotor and with a correspondingly curved inner edge of the wing, at which the center of the spherical surface lies on the pivot axle. In this way also the hub in its entirety can be rotationally symmetric. Since there is no mutual rotation at the inner edges but only pivoting the seal may here be established in some other way, for instance with a below like device (FIG. 24). (FIGS. 19, 20, 21, 22, 23, 24)

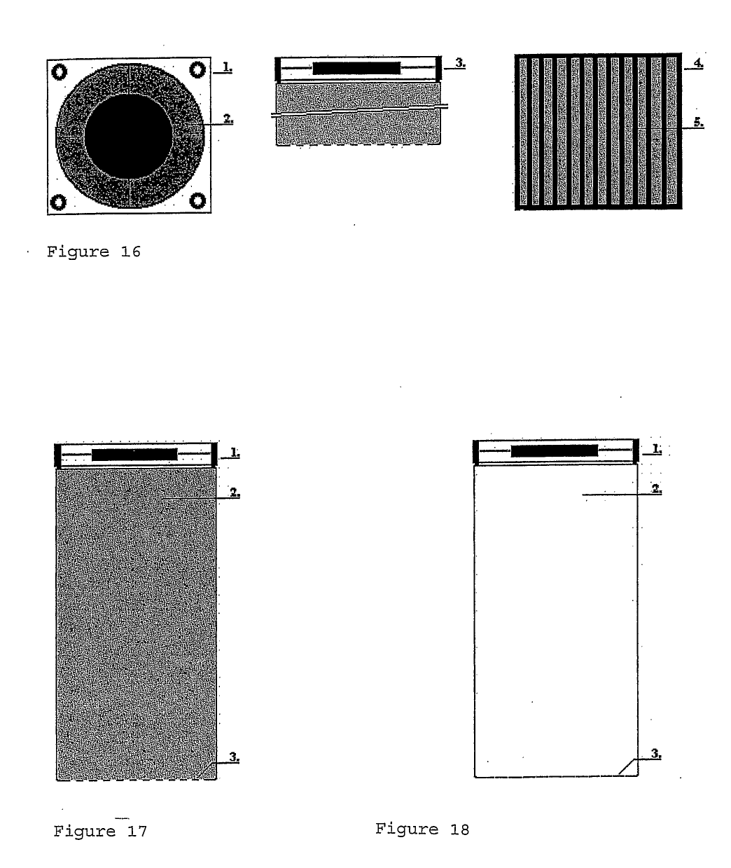

In the FIGS. 17, 18 a loudspeaker is shown comprising a rotating loudspeaker element in accordance with the invention arranged in a box. The loudspeaker box is not entirely closed but via a flow brake or restriction connected to the surrounding. In this way the risk is eliminated of the rotor being subjected to stall, that is that air transport stops entirely despite the rotation of the rotor. By choosing material and openings the resistance against the flow can be adapted so that it becomes frequency dependent so that optimum flow through the rotor is optimized dependent on frequency. In this way generated pressure can be optimized, stall avoided as well as acoustic short circuiting where inhalation of the pressure wave takes place. (FIGS. 16, 17 18)

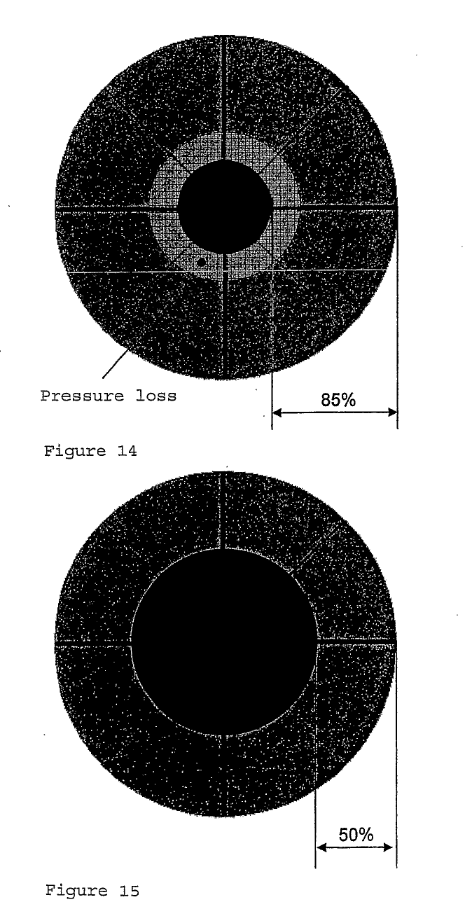

Since the efficiency of the component largely is ruled by how well the pressure is built up the blades primarily have to be designed for pressure and not for flow. The largest pressure build up takes place where the blade velocity is as largest. Low blade velocity result in leakage at high pressure and reduced efficiency. This means that the blades should have a blade velocity as high as possible for good efficiency in pressure building. Since the blade velocity is low in the center of the rotor this means that leakage will occur if the blades reach all the way in. A solution to this problem is to design smaller blades and allow the kernel to cover the part where the blade velocity is too low. For efficient build up the blades must be less than 80% of the radius of the rotor. In FIG. 14 a rotor is shown with blades larger than 80%, the area subjected to pressure loss is marked. In FIG. 15 a rotor is shown with blades smaller than 80%. (FIGS. 14, 15)

In order to further increase the efficiency at the pressure build up several layers of blades may be designed in the rotor. One can also consider to mount rotors after each other. Since the rotation generates a rotation phenomena in the modulated media (e.g. air) one may advantageously allow the rotors to rotate in alternating rotational directions since this leads to the rotors being able to use the rotation phenomena occurring in the media (e.g. air).

The invention can be used at all types of elements that with a rotating movement can transport air (or liquid), that is also radial fans, tangential fans, turbines et cetera in turbines one may advantageously by integration of the technique use the technique in the turbine steps. In many situations disturbing sound is generated by rotating air transporting elements and by means of the invention one may consider to reduce these either by the arranging of an extra rotor propeller et cetera or by controlling the rotating element that generate the sound, this in particular since these sounds often are continues.

The pitch of a wing is in principle the angle of the wing in relation to its plane of rotation. Since however the shape of the wing or blade may influence for instance the air transporting the shape of the wing may increase or decrease the actual pitch to what we could call effective pitch. Consequently pitch modulations may be achieved with a modulation of the shape of the wings, for instance by means of large piezoelectric elements.

The invention may even be put to use at wind driven generators where a large wing provided rotor is rotated by the wind. The blades may have a fixed basic pitch corresponding to that of a normal rotor but provided with means allowing modulation around or from this basic pitch. Here the modulations may in particular be used to reduce sound. Also the basic pitch may be controlled by control means that are independent of the means for modulating the wing pitch. With so large wings the conditions may vary over the turn of the rotor due to different wind speed at the top and bottom as well as the passing of the mast and one may consider to vary the modulation over the turn of the rotor.

In practical tests it has been discovered that when modulating the pitch of the blades to reduce sound also the efficiency of the fan or power generation has improved. This phenomena may also be used to control the modulation, that is controlled to give maximum power from a connected generator.

It also deserves to be mentioned that the principles of the invention are very possible to apply widely with regard to the acoustic frequency as well as different air speeds and sizes of the devices.

Since the invented concept as described above is possible to use as an acoustic wave generator as well as a microphone these functions can be combined in the same device that so to say can feel its way to the correct modulation in order to achieve for instance sound inhibiting or attenuation. Alternatively an external microphone that may or may not be of the same type be used to obtain a feedback that can be used to minimize the sound. Such a sound reduction will be very efficient since the noise is reduced at the source.

1-31. (canceled)

32. Combined fan and loudspeaker element, comprising a motor driven rotor provided with wings or blades, which wings or blades are adjustable to their effective pitch, so that transported air volume and achieved momentary air pressure respectively at rotation of the rotor can be modulated corresponding to a desired sound signal by a varying of the pitch of the wings or blades around a position with a pitch corresponding to the desired air transport.

33. Element according to claim 32, wherein permanent magnets are arranged on or integrated with blades or wings, and a fixed coil or coils are arranged for influencing the magnets for pivoting the wings or blades.

34. Element according to claim 33, wherein the wings have integrated coils.

35. Element according to claim 32, wherein the altering of the pitch of the wings or blades is done by a piezoelectric effect.

36. Element according to claim 32, wherein the pivot axle of each wing or blade extends approximately through the pressure center or slightly in front of this seen in the direction of the rotation.

37. Element according to claim 32, wherein load dependent speed variations caused by signal modulated wing angles is compensated by a flywheel or active speed control.

38. Element according to claim 32, wherein the wing angle is controlled with active

39. Element according to claim 32, comprising a circular rotor provided with one or several wings.

40. Acoustic element including a rotor with wings that can be modulated as to their pitch wherein the wings are coupled to a common control and/or sensor.

41. Acoustic element according to claim 40, wherein the control comprises a coil and a permanent magnet.

42. Combined air or gas driven rotor and loudspeaker element, comprising a rotor provided with wings or blades, which wings or blades are adjustable to their effective pitch, so that for the generation of sound the effective pitch can be modulated relative to pitch value chosen for the air driven rotation of the rotor.

43. Element according to claim 42, wherein permanent magnets are arranged on or integrated with blades or wings and a fixed coil or coils are arranged for influencing the magnets for pivoting the wings or blades.

44. Element according to claim 43, wherein the wings have integrated coils.

45. Element according to claim 42, wherein the altering of the pitch of the wings or blades is done by a piezoelectric effect.

46. Element according to claim 42, wherein the pivot axle of each wing or blade extends approximately through the pressure center or slightly in front of this seen in the direction of the rotation.

47. Element according to claim 42, wherein load dependent speed variations caused by signal modulated wing angles is compensated by a flywheel or active speed control.

48. Element according to claim 42, wherein the wing angle is controlled with

49. Element according to claim 32, comprising a circular rotor provided with one or several wings.

50. Combined fan and microphone, wherein sensors are arranged in the wings or blades, or a common sensor is coupled to the wings, sensing a variation in effective pitch around a pitch value corresponding to the desired air transport.

51. Combined fan and microphone, according to claim 50, wherein the sensing of the pitch modulation of the wings or blades caused by sound is by optic or piezoelectric effect.

52. Combined air or gas driven rotor and microphone, comprising a rotor provided with wings or blades, which wings or blades are provided with sensors or coupled to a common sensor, that can sense the effective pitch modulations of the wings or blades around a pitch value chosen for the air driven rotation of the rotor, these pitch modulations corresponding to the sound that is to be registered.

53. Combined air or gas driven rotor and microphone, according to claim 52, wherein the sensing of the pitch of the wings or blades is by optic or piezoelectric effect.

54. Combined airflow meter and microphone, comprising an airflow or motor driven rotor provided with as to their pitch freely moveable wings or blades, which wings or blades are detectable as to their pitch so that transported air volume can be calculated from the mean pitch value and the registered sound corresponds to the pitch modulations around said mean pitch value.

55. Combined airflow meter and microphone according to claim 54, wherein the sensing of the pitch of the wings or blades is by optic or piezoelectric effect.

56. Combined by airflow or motor driven rotor and acoustic element, comprising around this basic pitch value, the first sensor or control corresponding to air volume or power and the second sensor or control corresponding to the sound that is sensed or generated.

57. Rotor provided with wings or blades that are adjustable to their pitch wherein two adjustment mechanisms are present, a first basic mechanism to set a basic pitch value for the wings or blades, and a second mechanism that can modulate the pitch value around the basic pitch value.

58. Rotor according to claim 57, wherein the basic pitch is set at fabrication of the rotor.

59. Rotor according to claim 57, wherein the pitch modulation is achieved by a modulation of the shape of the wings or blades of the rotor.

60. Rotor according to claim 59, wherein pitch modulation is achieved by a piezoelectric effect.

61. Method for generating a sound/airflow that can be modulated, comprising a rotor provided with adjustable wings or blades the angles of the wings or blades are so adjusted that the degree of pitch (angling/bending of wing), is controlled so that transported air volume and achieved air pressure respectively can be modulated corresponding to a desired sound signal/pressure way.

62. Method for the measuring of modulated sound or airflow, wherein the air or other medium is led through a rotating rotor with easily moveable wings or blades and that a transported volume can be measured via the angle deflections of the wings or blades.

63. Microphone comprising a wing provided on a rotor wherein the wing senses sound flow or pressure variations via the angle the wings receive when the rotor is rotated in air

64. Loudspeaker comprising a motor driven rotor with wings, the pitch angle of which can be modulated wherein the momentary power delivered to the motor is proportional to the power delivered to control of the wings.

65. Method for reproduction of sound, wherein a motor driven loudspeaker rotor with to their pitch adjustable wings or blades the wing adjustment is momentarily controlled in accordance with the momentary sound pressure of the sound that is to be delivered.

66. Acoustic element including a rotor with wings that can be modulated as to their pitch wherein the wing area essentially covers the entire flow through area of the loudspeaker element or microphone element.

67. Acoustic element including a rotor with wings that can be modulated as to their pitch wherein the rotor is surrounded by a spherical sealing wing area for the surrounding housing with center on the spherical surface in the center of the rotor so that the distance between the housing and the wings remain constant independent of the pivoting of the wings of the rotor.

68. Acoustic element including a rotor with wings that can be modulated as to their pitch wherein between the wings and the center of the rotor a rotationally symmetric advantageously spherical sealing slit is arranged between rotor center and wing, the rotationally symmetric surface having its axle coinciding with the pivot axle of the wing so that the distance between the wings and the rotor remain constant independent of the pivoting of the wings of the rotor.

69. Acoustic element including a rotor with wings that can be modulated as to their pitch wherein between rotor center and inner end of the wing a bellow device is arranged for sealing.

70. Acoustic element including a rotor with wings that can be modulated as to their pitch wherein the wings are provided with balance weights preferably arranged perpendicularly against the wing surface so that with the pitch angle varying centrifugal forces on the wings are compensated.

71. Acoustic element including a rotor with wings that can be modulated as to their pitch wherein the pivot axle of each wing or blade goes behind the pressure center seen in the direction of rotation so that with the pitch angle varying centrifugal forces on the wings are compensated.

72. Acoustic element including a rotor with wings that can be modulated as to their pitch wherein the pivoting center for change of pitch for the wings is placed somewhat in front of the symmetry wing of the wings so that the rear area of the wings become slightly larger and thereby provide increasing resistance against increasing pitch so that improved linearity is obtained for pressure and air transport as a response to a controlling signal.

73. Acoustic element including a rotor with wings that can be modulated as to their pitch wherein the element comprises several rotors mounted adjacent one another or in layers of blades for increased pressure/flow.

74. Acoustic element according to claim 73, wherein the rotors mounted adjacent one another or in layers with blades have alternating direction of rotation.

75. Acoustic element including a rotor with wings that can be modulated as to their pitch wherein the length of the blades is less than 80% of the radius of the rotor for increased pressure.

76. Acoustic element including a rotor with wings that can be modulated as to their pitch wherein the element is included as a part component in a turbine or fan.

77. Acoustic element including a rotor with wings that can be modulated as to their pitch comprising box that in addition to an opening in which the rotor is mounted includes one or several restricted or airflow damped openings, so that the flow through the rotor can be optimized for pressure optimizing and that stall can be prevented.
